(19) United States
(12) Patent Application Publication
(10) Pub. No.: US 2015/0367889 A1
(43) Pub. Date: Dec. 24, 2015

(54) Carrier Element and Energy Absorption Element of Hybrid Construction for a Motor Vehicle

(71) Applicant: Daimler AG, Stuttgart (DE)

(72) Inventors: Konrad EIPPER, Rottenburg (DE); Ozan SINGAR, Wendlingen (DE)

(21) Appl. No.: 14/410,744

(22) PCT Filed: Feb. 23, 2013
(86) PCT No.: PCT/EP2013/000537

§ 371 Date: Dec. 23, 2014

(30) Foreign Application Priority Data
Jun. 27, 2012 (DE) 10 2012 012 745.6

(51) Int. Cl. B62D 21/15; B62D 29/00

(52) U.S. Cl. CPC B62D 21/15; B62D 29/001

(57) ABSTRACT

A carrier element and an energy absorption element for a motor vehicle each can include a metal element connected to a plastic element. The metal element and the plastic element are formed to abut onto each other in a predominant surface region of the carrier element or energy absorption element and are at a distance from each other in at least one surface region of the carrier element or energy absorption element, forming a hollow chamber.

### BACKGROUND AND SUMMARY OF THE INVENTION

Exemplary embodiments of the invention relate to a carrier element in hybrid construction for a motor vehicle, as well as to an energy absorption element in hybrid construction for a motor vehicle.

Hybrid constructions of components for the series production of passenger motor vehicles, consisting of a metal element and a plastic element, are known in a plurality of embodiments. First, a reduction in weight of the respective component is thus achieved with the savings connected to this with respect to use of plastic. With regard to the carrier elements for the construction of the respective motor vehicle, the benefits of both materials of the metal element and the plastic element can moreover be used.

German patent document DE 10 2009 042 272 A1 discloses a carrier element in hybrid construction having an outer carrier element made from sheet metal that is stiffened on the inner side by a reinforcement structure made from plastic and comprising a plurality of ribs. A similar design is also disclosed in German patent document DE 20 2010 002 099 U1.

Furthermore, German patent document DE 10 2004 049 396 A1 discloses a carrier having a base body and a plastic coating lying on the inside that is formed by a film channel made from plastic and arranged in the hollow space of the base body. In the overlap region with the base body, the plastic coating abuts onto the base body over the entire surface area.

Furthermore, it is known to design energy absorption elements in such hybrid constructions for the reduction of forces as a result of accidents with vehicles. One example of this is disclosed in German patent document DE 197 17 473 in which a plastic element that is also tubular is arranged inside a tubular metal element. In the mutual overlap region, the tubular plastic element abuts onto the inner periphery of the tubular metallic element with its outer periphery.

Exemplary embodiments of the present invention are directed to a carrier element or an energy absorption element of the type named at the beginning, which is formed to be favorable in terms of weight and construction space and has advantageous deformation properties in the case of impact caused by an accident.

In order to create a carrier element of the type specified at the beginning, which is formed on the one hand to be particularly favorable in terms of weight and construction space and on the other hand to have advantageous deformation properties in the case of force impact caused by an accident, according to the invention the metal element and the plastic element are formed to abut onto each other in a predominant surface region of the carrier element and are at a distance from each other in at least one surface region of the carrier element, forming a hollow chamber.

The metal element, which is a converted metal sheet, is stiffened by the plastic element abutting onto it extensively in a manner that is favorable in terms of construction space and weight. Thus, a thin-walled steel sheet can be used that is formed, for example, from high-strength steel or from spring steel, the steel sheet being reinforced by the plastic element. Here, the plastic element is preferably formed as a plastic layer and/or plastic film, which has an at least substantially uniform layer thickness. Due to the use of the metal element, the carrier element has a high energy absorption capacity in the case of an accident as well as ductile properties.

In such a surface region in which the plastic element and the metal element are at a distance from one another in the form of a hollow profile, a type of box profile is created, whereby the connection of the plastic element and the metal element has particularly high structural rigidity. Thus, the carrier element can transfer forces caused by an accident very well to other structural components or can ensure a corresponding load distribution.

In a further embodiment of the invention, it has been shown to be advantageous for the implementation of an only very low weight if the metal element is designed as thin-walled sheet metal, in particular as a thin-walled steel sheet. A favorably paintable outer side of the carrier element can also be hereby presented.

A further advantageous embodiment provides that the plastic element is formed from a fiber-reinforced plastic. Due to such a plastic, a very light and particularly stable and stiff plastic element is created.

A further embodiment provides that a fiber reinforcement of the plastic element is aligned to the surface region abutting onto the metal element and the at least one surface region of the carrier element forming the hollow chamber. Such an alignment can, in particular, provide that fiber layers of the fiber reinforcement are, for example, adapted in terms of direction and number to stresses occurring during force impact caused by an accident. Thus, for example, it is conceivable that in such surface regions in which the hollow chamber is formed, a more stable fiber reinforcement is provided than in the predominant surface region in which the metal element and the plastic element abut onto each other. For example, it is also possible to provide more fibers in the surface region of the hollow chamber than in the predominant surface region of the carrier element.

The carrier element can, particularly advantageously, be used as a longitudinal beam element or as a cross member element—in particular as a flexible cross member—of the motor vehicle. Such longitudinal beam elements and/or cross member elements serve especially for the absorption and/or for the dissipation of loads caused by accidents in order to protect the passenger compartment and thus the vehicle passenger. Herein, the advantages of both materials of the metal element and of the plastic element are applied, wherein an advantageous level of ductility is ensured by the metal element and high rigidity of the carrier element is ensured by the plastic element. Furthermore, the metal element can be formed with low material thickness, wherein a sufficient reinforcement or stiffening is ensured by the plastic element.

In order to create a particularly high level of firmness and rigidity of the carrier element, a further embodiment provides that the hollow chamber is at least partially filled by a plastic. Thus, the deformation properties of the carrier element can also be adjusted according to need. The plastic with which the hollow chamber is at least partially filled is preferably a foam element. In other words, the hollow chamber is at least partially filled with foam by the plastic in a manner that is favorable in terms of weight.

The carrier element is furthermore distinguished by the plastic element extending over at least approximately the entire carrier element, whereby the metal element is stiffened particularly extensively.

A further embodiment provides that at least one cable, channel or similar wire is transferred into the hollow chamber. Thus, a particularly high degree of integration is created, wherein the hollow chamber is used, on the one hand, for the stiffening and, on the other hand, for the concealed reception of a corresponding wire, for example for a sensor.

In order to create an energy absorption element for a motor vehicle, which is formed to be particularly favorable in terms of weight and construction space, and has particularly advantageous properties during an accident, the metal element and the plastic element are formed to abut onto each other in a surface region of the energy absorption element and are at a distance from each other in at least one surface region of the energy absorption element, forming a hollow chamber.

The embodiments and advantages explained in connection with the carrier part according to the invention also apply for the energy absorption element according to the invention.

### BRIEF DESCRIPTION OF THE DRAWING FIGURES

Further advantages, features and details of the invention result from the description below of preferred exemplary embodiments as well as by means of the drawing. Here are shown:

FIG. 1 a schematic cross-sectional view of a carrier element in hybrid construction in the form of a flexible cross member for a passenger motor vehicle;

FIG. 2 a schematic cross-sectional view of a carrier element in hybrid construction in the form of a longitudinal beam element for a passenger vehicle;

FIG. 3 a schematic cross-sectional view of a carrier element in hybrid construction in the form of a cross beam element for a passenger vehicle and

FIG. 4 a schematic cross-sectional view of an energy absorption element in hybrid construction for a passenger motor vehicle.

### DETAILED DESCRIPTION

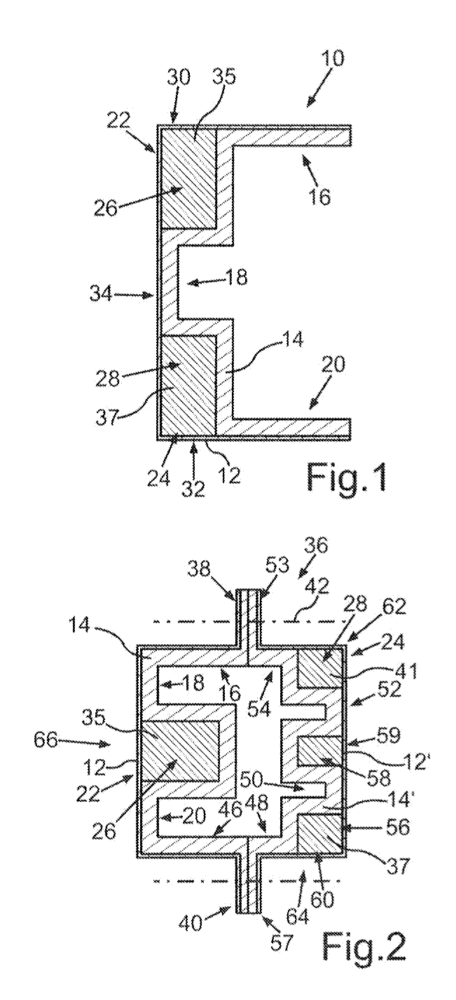

In FIG. 1, a carrier element in the form of a flexible cross member 10 for a passenger vehicle is depicted in a schematic cross-sectional view. The flexible cross member 10 is therein designed in hybrid construction and comprises a metal element 12 formed from a metallic material as well as a plastic element 14 connected to this. The flexible cross member 10 is, for example, allocated to a bumper of the passenger motor vehicle and extends in the assembled state at least substantially in the vehicle transverse direction. The flexible cross member 10 serves in particular to absorb loads caused by accidents in the case of a force impact caused by an accident—for example as a consequence of a frontal impact—and to dissipate or distribute these in structural components arranged behind this in the vehicle longitudinal direction, such as longitudinal beam elements of the passenger motor vehicle.

The metal element 12 is arranged on the outer side in the vehicle longitudinal direction and is created by a thin-walled metal sheet, in particular made from steel or spring steel. Alternatively, instead of a steel or a steel alloy, another metal alloy, for example an aluminum alloy, would also, of course, be conceivable. An open hollow cross-section is presently formed by the metal element 12 in which the plastic element 14 is arranged. The plastic element 14, which is formed as a plastic layer or plastic overlay having at least substantially the same remaining layer thickness, stiffens the thin-walled metal element 12. Here, the plastic element 14 extends over at least approximately the entire height and width of the metal element 12 such that this is not only partially but extensively connected to the plastic element 14, in comparison to other production methods, and is stiffened and reinforced by this.

Therein, the metal element 12 and the plastic element 14 are formed to abut onto each other in a predominant surface region of the flexible cross member 10. The predominant surface region is formed presently by three surface partial regions 16, 18, 20. The connection of the metal element 12 to the plastic element 14 also occurs at least in one part of these surface partial regions 16, 18, 20. Such a connection can, for example, be implemented by adhesion or by the direct application of the plastic element 14 to the metal element 12.

In the surface partial regions 16, 18, 20, the metal element 12 is correspondingly reinforced by the abutting plastic elements 14 and has, for example, very high buckling resistance. Thus, a particularly stiff connection of the metal element 12 and the plastic element 14 is created.

In further surface regions 22, 24, the metal element 12 and the plastic element 14 are at a distance from each other, forming respective hollow chambers 26, 28. With regard to the vehicle vertical direction, the hollow chamber 26 is formed here in an upper corner region 30 and the hollow chamber 28 in a lower corner region 32 of the flexible cross member 10. In a central region 34 arranged in the vehicle vertical direction between the corner regions 30, 32, the plastic element 14 abuts onto the metal element 12 in the surface partial region 18.

Due to the spacing of the plastic element 14 from the metal element 12 in the further surface regions 26, 28, box profiles or profile elements are thus formed having a closed cross-section in the peripheral direction, which extend at least substantially in the vehicle transverse direction and ensure a very high level of rigidity of the flexible cross member 10, in particular in the further surface regions 22, 24. The hollow chamber 26 and the hollow chamber 28 are limited to the rear in the vehicle longitudinal direction and downwards in the vehicle vertical direction by the plastic element 14. The hollow chambers 26, 28 are limited to the front in the vehicle longitudinal direction and upwards in the vehicle vertical direction by the metal element 12. The hollow chambers 26, 28 are presently at least partially filled by a foam material 35, 37 in order to, for example, adjust the firmness or rigidity and hereby to adjust the distortion properties of the flexible cross member 10 according to requirement.

The hollow chamber 26 and/or 28 can also fulfil a double function and can indeed not only be used for the stiffening or reinforcement of the flexible cross member 10, but also as receiving spaces for at least one component of the passenger vehicle. Such a component can be, for example a wire that is not depicted in FIG. 1. Such a wire can, for example, be used to connect a distance sensor, which is arranged, like the flexible cross member 10, in a front end region of the passenger vehicle, to a current supply and/or to couple it to a control device of the passenger vehicle, such that the control device and the distance sensor can exchange signals. Thus, cables, channels or similar wires can been arranged in a space-saving manner and hidden in the hollow chambers 26, 28.

FIG. 2 shows a further embodiment of a carrier element in the form of a longitudinal beam element 36 in hybrid construction for a passenger vehicle in a cross-sectional view. The longitudinal beam element 36 comprises two respective metal elements 12, 12′ formed from a metallic material, which represent respective shell elements of the longitudinal beam element 36. In other words, the longitudinal beam element 36 is formed in monocoque construction in which the metal elements 12, 12′ are connected to one another via respective connection flanges 38, 40.

The metal elements 12, 12′ have a respective, open hollow cross-section in which a respective plastic element 14, 14′ is predominantly arranged. Here, what is depicted for the metal element 12 of the flexible cross member 10 is able to be transferred directly to the metal elements 12, 12′ of the longitudinal beam element 36. Likewise, what is depicted for the plastic element 14 of the flexible cross member 10 is able to be transferred directly to the plastic elements 14, 14′ of the longitudinal beam element 36. The respective metal elements 12, 12′ and the respective plastic elements 14, 14′ are formed to abut onto one another in a predominant surface region of the longitudinal beam element 36. This predominant surface region is presently composed of surface partial regions 16, 18, 20, 46, 48, 50, 52, 53, 54 and 57. In further surface regions 22, 24, 56, the respective metal elements 12, 12′ and the respective allocated plastic elements 14, 14′ are at a distance from one another, forming respective hollow chambers 26, 28, 58, 60, 62. The hollow chambers 28, 60 are therein arranged in a respective corner region of the longitudinal element 26, while the hollow chambers 26, 58 are arranged in a central region.

As in the case of the cross beam element 10, the thin-walled metal elements 12, 12′ are stiffened and reinforced by the plastic elements 14, 14′. Respective profile parts extending in the longitudinal extension direction of the longitudinal beam element 36 are formed by the hollow chambers 26, 28, 60, which lead to particularly high rigidity of the longitudinal beam element 36. In the installation position, the longitudinal beam element 36 extends at least substantially in the vehicle longitudinal direction, such that the profile parts formed by the hollow chambers 26, 28, 58, 60 also extend in the vehicle longitudinal direction. The hollow chambers 26, 28, 58, 60 are presently completely filled with a respective plastic 35, 37, 39, 41.

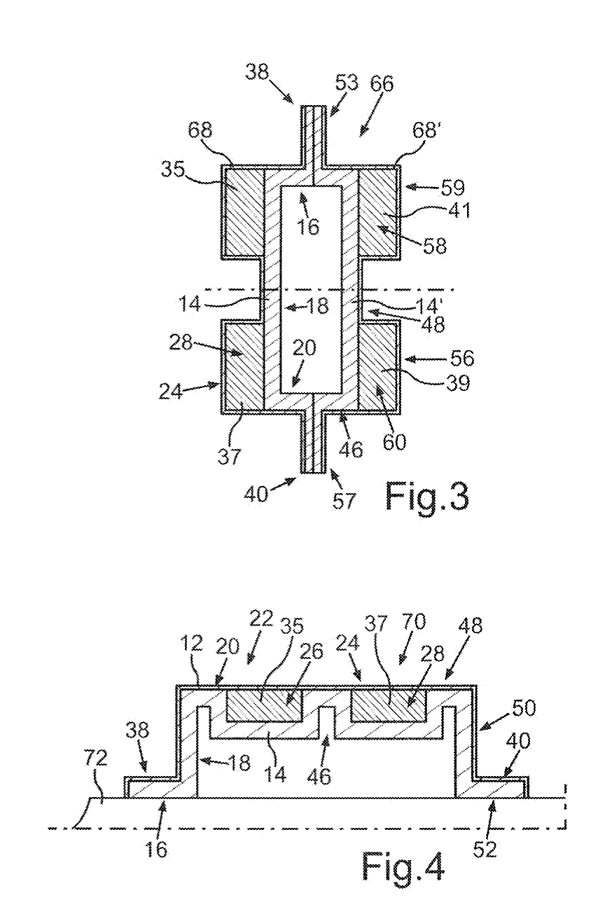

FIG. 3 shows a further embodiment of a carrier element in the form of a cross beam element 70 for a passenger vehicle, which is presently connected to a vehicle floor 72 of the passenger motor vehicle via respective connection flanges 38, 40. The cross beam element 70 can be, for example, a seat cross member. Also, the cross member element 70 is formed in hybrid construction and comprises a metal element 12 as well as a plastic element 14. The plastic element 14 and the metal element 12 are formed to abut onto each other in a predominant surface region of the cross member element 70, wherein this predominant surface region is composed of surface partial regions 16, 18, 20, 46, 48, 50, 52. In further surface regions 22, 24, the metal element 12 and the plastic element 14 are at a distance from each other, forming a respective hollow chamber 26, 28. The respective hollow chambers 26, 28 are presently completely filled by a plastic 35, 37, in particular a foam material.

Here, the plastic elements 14, 14′ are preferably provided with a fiber reinforcement which cannot be seen in the figures, which is adapted to the respective stresses in a fiber layer. Thus, for example, it is conceivable to introduce a larger number of fibers into the surface regions 22, 24, 56, 59 that are at a distance to one another, than into the surface partial regions 16, 18, 20, 46, 48, 50, 52, 53, 54, 57, in which the plastic element 14 or 14′ forms the sandwich-like abutting connection with the metal element 12 or 12′ or with the metal element 68, 68′.

Preferably, such fibers made from carbon, glass or aramid are used as fibers. The plastic of the plastic element 14, 14′ serves therein as a matrix into which the fibers of the fiber reinforcement are embedded at least partially. Here, for example, a duroplast or duromer is used as the plastic.

FIG. 4 shows an energy absorption element 66 to which the described hybrid construction is applied. Therein, the energy absorption element 66 comprises two respective metal elements 68, 68′ and respective plastic elements 14, 14′ that are formed to abut onto one another in a preferably predominant surface region of the energy absorption element 66. Here, this predominant surface region is formed by partial surface regions 16, 18, 20, 46, 48, 50, 52, 53. Thus, the metal elements 68, 68′ can be designed with only a low material thickness and thus favorably in terms of weight, and are reinforced by the plastic elements 14, 14′. The metal elements 68, 68′ provided with the plastic elements 14, 14′ are connected to one another via respective connection flanges 38, 40.

In further surface regions 22, 24, 56, 59, the metal elements 68, 68′ are in turn at a distance from one another, forming respective hollow chambers 26, 28, 58, 60 which can be filled completely with a respective plastic.

In its state connected to the body of the passenger motor vehicle, the energy absorption element 66 extends at least substantially in the vehicle longitudinal direction and in particular serves to convert impact energy, forming it into deformation energy. Here, for example, the flexible cross member 10 can be connected to respective longitudinal beam elements 36 via two energy absorption elements 66 at a distance to one another in the vehicle transverse direction.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A motor vehicle carrier element, comprising:
a plastic element; and
a metal element connected to the plastic element,
wherein the metal element and the plastic element abut onto each other in a predominant surface region of the carrier element and are at a distance from each other in at least one surface region of the carrier element, wherein the distance between the plastic and metal element in the at least one surface region forms a hollow chamber.

11. The motor vehicle carrier element of claim 10, wherein the metal element is a thin-walled steel sheet.

12. The motor vehicle carrier element of claim 10, wherein the plastic element is formed at least substantially as a plastic layer made from a fiber reinforced plastic.

13. The motor vehicle carrier element of claim 12, wherein a fiber reinforcement of the plastic element is aligned on the surface region abutting onto the metal element and the at least one surface region of the carrier element forming the hollow chamber.

14. The motor vehicle carrier element of claim 12, wherein the hollow chamber is at least partially filled by a plastic.

15. The motor vehicle carrier element of claim 14, wherein the hollow chamber is at least partially filled with foam by the plastic.

16. The motor vehicle carrier element of claim 12, wherein the plastic element extends over at least approximately the entire metal element.

17. The motor vehicle carrier element of claim 12, wherein the hollow chamber includes at least one cable or channel wire.

18. A motor vehicle energy absorption element, comprising:
a plastic element; and
a metal element connected to the plastic element,
wherein the metal element and the plastic element are formed to abut onto each other in a surface region of the energy absorption element and are at a distance to each other in at least one surface region of the energy absorption element, wherein the distance between the plastic and metal element in the at least one surface region forms a hollow chamber.
